(19) United States
(12) Patent Application Publication
(10) Pub. No.: US 2026/0078039 A1
(43) Pub. Date: Mar. 19, 2026

(54) AUTOMATIC ADVANCEMENT DEVICES AND METHODS FOR TIN OXIDE ELECTRODES OF ELECTRONIC GLASS FURNACES

(71) Applicant: CAIHONG DISPLAY DEVICES CO., LTD., Xianyang (CN)

(72) Inventors: Feng ZHANG, Xianyang (CN); Wei YANG, Xianyang (CN); Longjiang ZHAO, Xianyang (CN)

(73) Assignee: CAIHONG DISPLAY DEVICES CO., LTD., Xianyang (CN)

(21) Appl. No.: 19/398,017

(22) Filed: Nov. 23, 2025

Related U.S. Application Data
(63) Continuation-in-part of application No. PCT/CN2025/111262, filed on Jul. 29, 2025.

(30) Foreign Application Priority Data
Jul. 30, 2024 (CN) 202411033811.1

(51) Int. Cl. C03B 5/16; C03B 5/02

(52) U.S. Cl. CPC C03B 5/16; C03B 5/02

(57) ABSTRACT

An automatic advancement device for a tin oxide electrode of an electronic glass furnace is provided. The device comprises at least one motor drive unit, a motor guide unit, and a motor control unit. Each motor drive unit includes a worm gear set, a coupling, a push rod, and a reduction motor. The worm gear set is connected to the reduction motor via the coupling. The push rod is installed at an end of the worm gear set. The motor guide unit includes a transport device on which the motor drive unit is installed and a guide device installed at a bottom of the transport device. The transport device moves along the guide device to control an advancement direction of the motor drive unit. The motor control unit is connected to the reduction motor and configured to control the reduction motor to advance the push rod.

### CROSS-REFERENCE TO RELATED APPLICATIONS

This application is a Continuation-in-part of International Patent Application No. PCT/CN2025/111262, filed on Jul. 29, 2025, which claims priority to Chinese Patent Application No. 202411033811.1, filed on Jul. 30, 2024, the entire contents of each of which are hereby incorporated by reference.

### TECHNICAL FIELD

The present disclosure relates to the field of auxiliary equipment for electronic glass furnaces, and specifically to an automatic advancement device and method for a tin oxide electrode of an electronic glass furnace.

### BACKGROUND

Electric heating based on electronic glass furnaces is currently the primary heating process in the glass production industry, mainly utilizing molybdenum electrodes and tin oxide. The tin oxide not only has good electrical conductivity but also functions to clarify the glass, making tin oxide electrodes the most widely used. However, the tin oxide electrodes are continuously consumed during operation and need to be periodically advanced into the furnace at their end face to maintain a stable voltage. With the continuous improvement of furnace capacity, electrode specifications are constantly increasing, and the resistance to advancing the electrodes is also continually growing, with the maximum resistance reaching about 3000 kg. The traditional screw jacking process relies on manual operation, which involves high work intensity. Furthermore, during the process of lengthening the screw, its stiffness continuously decreases, making the screw prone to bending and jamming. Additionally, in the traditional screw jacking process, the screw has an excessively large length-to-diameter ratio, making it susceptible to Euler buckling under axial pressure, leading to bending and jamming inside the sleeve.

Therefore, it is desirable to provide an automatic advancement device and method for a tin oxide electrode of an electronic glass furnace, which can solve the problem of screw bending and jamming caused by the prior art when advancing the electrode.

### SUMMARY

One or more embodiments of the present disclosure provide an automatic advancement device and method for a tin oxide electrode of an electronic glass furnace, which can solve the problem of screw bending and jamming caused by the prior art when advancing the electrode.

In a first aspect, one or more embodiments of the present disclosure provide an automatic advancement device for a tin oxide electrode of an electronic glass furnace. The device comprises at least one motor drive units, a motor guide unit, and a motor control unit. Each of the at least one motor drive unit includes a worm gear set, a coupling, a push rod, and a reduction motor, The worm gear set is connected to the reduction motor via the coupling, and the push rod is installed at an end of the worm gear set. The motor guide unit includes a transport device and a guide device. The motor drive unit is installed on the transport device, and the guide device is installed at a bottom of the transport device. The transport device moves along the guide device to control an advancement direction of the motor drive unit during use. The motor control unit is connected to the reduction motor, and configured to control the reduction motor to advance the push rod.

In some embodiments, the motor drive unit further includes a handwheel, and the handwheel is disposed at an upper end of the worm gear set.

In some embodiments, the transport device is a trolley, the guide device is a rail, and the rail is installed at a bottom portion of the trolley.

In some embodiments, the motor drive unit further includes an up-down limit device and a front-rear limit device, and the up-down limit device and the front-rear limit device are installed at a connection between the trolley and the rail.

In some embodiments, a limit docking structure of the up-down limit device is a U-shaped notch.

In some embodiments, a limit docking structure of the front-rear limit device is an elongated through-hole.

In some embodiments, an end of the push rod is provided with an insulating ceramic head.

In a second aspect, one or more embodiments of the present disclosure provide an automatic advancement method for a tin oxide electrode of an electronic glass furnace, implemented based on the automatic advancement device provided in one or more embodiments of the present disclosure. The method comprises: after pushing the transport device to a designated position via the guide device, fixedly positioning the transport device; controlling an end of the push rod to contact an electrode reinforcement pressing plate by adjusting an extension amount of the worm gear set; and controlling, by the motor control unit, the reduction motor to advance the push rod corresponding to the reduction motor to complete the advancement of the tin oxide electrode.

One or more embodiments in the present disclosure provide at least the following beneficial effects: The advancement is performed by the motor control unit cooperating with the worm gear set, the coupling, the push rod, and the reduction motor, and the advancement direction is controlled on the motor guide unit. Therefore, the present disclosure can solve the problem of screw bending and jamming caused by the existing technologies when advancing the electrode. Furthermore, the use of motor drive is more labor-saving and efficient, provides greater pushing force, and can meet the requirements for advancing large-sized electrodes. Through the configuration of the motor control unit, the advancement amount can be precise to the millimeter level, making it more accurate and efficient. Furthermore, the transport device adopts a trolley, the guide device adopts a rail, and the motor drive unit is installed on the trolley, which can meet operational requirements at different positions and offers greater flexibility.

### BRIEF DESCRIPTION OF THE DRAWINGS

The present disclosure will be further illustrated by way of exemplary embodiments, which will be described in detail through the accompanying drawings. These embodiments are not limiting, and in these embodiments, the same numerals represent the same structures, wherein:

FIG. 1 is a schematic structural diagram of a motor drive unit according to some embodiments of the present disclosure;

FIG. 2 is a schematic structural diagram of an automatic advancement device for a tin oxide electrode of an electronic glass furnace according to some embodiments of the present disclosure;

FIG. 3 is a schematic diagram of an implementation of an automatic advancement device for a tin oxide electrode of an electronic glass furnace according to some embodiments of the present disclosure;

FIG. 4 is a flowchart of an exemplary automatic advancement process for a tin oxide electrode of an electronic glass furnace according to some embodiments of the present disclosure;

FIG. 5 is an exemplary flowchart of a tin oxide electrode advancing process according to some embodiments of the present disclosure;

Reference numerals in the drawings: 11, trolley; 12, rail; 13, limit device; 13-1, up-down limit device; 13-2, front-rear limit device; 21, worm gear set; 22, handwheel; 23, reduction motor; 24, coupling; 25, push rod; 26, current sensor; 31, electrode reinforcement pressing plate.

### DETAILED DESCRIPTION

In the following description, certain exemplary embodiments are presented by way of illustration only. The described embodiments may be modified in various different ways without departing from the spirit or scope of the present disclosure. Consequently, the drawings and description are to be regarded as illustrative in nature and not restrictive.

In the description of the present disclosure, it is to be understood that terms such as “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” and “circumferential” indicate orientations or positional relationships based on those shown in the accompanying drawings. These terms are used merely for the convenience of describing the present disclosure and simplifying the description, and do not indicate or imply that the referred apparatus or elements must have a specific orientation or be constructed or operated in a specific orientation. Therefore, they should not be construed as limiting the present disclosure.

Furthermore, the terms such as “first” and “second” are used for descriptive purposes only and are not to be construed as indicating or implying relative importance or implicitly specifying the quantity of the indicated technical features. Thus, features defined by “first” or “second” may explicitly or implicitly include one or more of such features. In the description of the present disclosure, the term “a plurality of” means two or more, unless explicitly and specifically defined otherwise.

In the present disclosure, unless otherwise expressly specified and defined, terms such as “install,” “connect,” “link,” and “fix” should be interpreted broadly. For example, a connection may be a fixed connection, a detachable connection, or an integral connection; it may be a mechanical connection, an electrical connection, or a communication connection; it may be a direct connection, an indirect connection through an intermediary medium, or an internal communication between two elements or an interaction relationship between two elements. Those of ordinary skill in the art can understand the specific meanings of the aforementioned terms in the present disclosure based on the specific context.

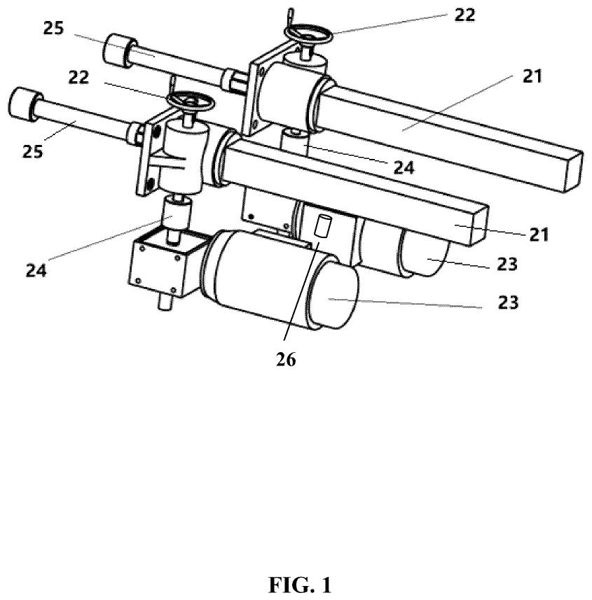

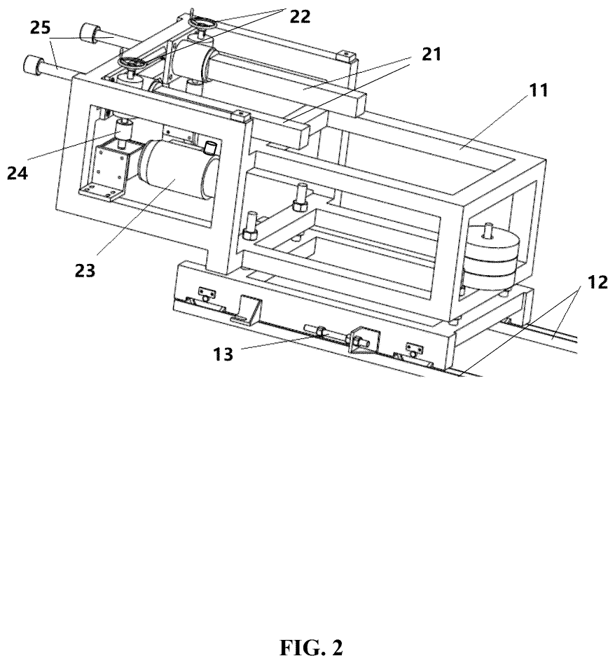

FIG. 1 is a schematic structural diagram of a motor drive unit according to some embodiments of the present disclosure. FIG. 2 is a schematic structural diagram of an automatic advancement device for a tin oxide electrode of an electronic glass furnace according to some embodiments of the present disclosure.

As shown in FIGS. 1 and 2, some embodiments of the present disclosure provide an automatic advancement device for a tin oxide electrode of an electronic glass furnace (hereinafter referred to as the automatic advancement device). The automatic advancement device comprises at least one motor drive unit 100, a motor guide unit, and a motor control unit.

The motor drive unit 100 is a device for driving the tin oxide electrode. The motor drive unit includes a worm gear set 21, a coupling 24, a push rod 25, and a reduction motor 23. The worm gear set 21 is connected to the reduction motor 23 via the coupling 24. The push rod 25 is installed at an end of the worm gear set 21.

The worm gear set 21 is a component that amplifies torque to provide a motive force for advancing the tin oxide electrode.

The coupling 24 is a component for connecting the worm gear set 21 and the reduction motor 23.

The push rod 25 is a component used for pushing the tin oxide electrode.

In some embodiments, an end of the push rod 25 is provided with an insulating ceramic head. The insulating ceramic head is a component made of an insulating ceramic material and installed at the end of the push rod 25. The insulating ceramic material typically employs high-purity aluminum oxide (Al₂O₃) or other high-performance engineering ceramics.

The reduction motor 23 is a motor that provides a driving force for advancing the tin oxide electrode. For example, the reduction motor 23 may be an Alternating Current (AC) reduction motor, a servo/stepper reduction motor, or the like.

The reduction motor 23 is configured to drive the worm gear set 21 to achieve high-efficiency torque input. Through torque amplification by the worm gear set 21, the push rod 25 is driven forward to achieve a thrust force required for the advancing operation.

In some embodiments, as shown in FIGS. 1 and 2, the motor drive unit further includes a handwheel 22, and the handwheel 22 is disposed at an upper end of the worm gear set 21.

The handwheel 22 is a component for adjusting the worm gear set 21. For example, the handwheel 22 may be configured to adjust an extension amount of the worm gear set 21, so as to allow the end of the push rod 25 to contact the electrode reinforcement pressing plate 31.

The electrode reinforcement pressing plate 31 is a component for bearing and transmitting force. The electrode reinforcement pressing plate 31 is installed at the end of the electrode (e.g., on an outer side of the electronic glass furnace) to compensate for the inherently limited impact and compressive strength of a material (e.g., tin oxide ceramic) of the electrode.

In some embodiments, the electrode reinforcement pressing plate 31 is configured to safely and effectively distribute and transmit the concentrated force generated by the advancement device to the electrode, thereby achieving smooth and controllable electrode advancement.

In some embodiments, the electrode reinforcement pressing plate 31 may be fixedly connected to the electrode. Manners of fixed connection include, but are not limited to, mechanical connection, high-temperature bonding, or the like. The mechanical connection may include fastening and fixing the electrode reinforcement pressing plate 31 to the end of the electrode using high-temperature alloy bolts. The high-temperature bonding may include adhering the electrode reinforcement pressing plate 31 to the end of the electrode using a high-temperature-resistant inorganic adhesive.

In some implementations, an insulating gasket may be placed between the electrode reinforcement pressing plate 31 and the electrode, forming a multi-stage insulation system.

In some embodiments, a material of the electrode reinforcement pressing plate 31 may include heat-resistant stainless steel (e.g., type 310S steel or 316L steel), a high-temperature nickel-based alloy, or the like.

In some embodiments, the electrode reinforcement pressing plate 31 may be disc-shaped or square-plate-shaped, and a diameter or a side length of the electrode reinforcement pressing plate 31 may be larger than an end face diameter of the push rod 25 to provide a sufficient force-bearing area.

In some embodiments, the insulating ceramic head installed at the end of the push rod 25 can directly contact the electrode reinforcement pressing plate 31, thereby effectively blocking current from grounding through the advancement device and preventing short-circuit incidents, while ensuring mechanical force transmission.

The motor guide unit is a device for restricting an advancement direction of the motor drive unit 100. The motor guide unit includes a transport device and a guide device. The motor drive unit 100 is installed on the transport device, and the guide device is installed at a bottom of the transport device. The transport device moves along the guide device to control the advancement direction of the motor drive unit 100 during use.

The transport device is a component for carrying and moving the motor drive unit 100. The bottom of the transport device cooperates with the guide device to form a slidable moving structure. In some embodiments, the transport device may also be a transmission platform, a sliding table, a gantry, or any other feasible structural form.

The guide device is a component for guiding the transport device and providing a directional movement path for the transport device. The guide device ensures that the motor drive unit moves close to the electrode along a required direction (e.g., the advancement direction), avoiding deviation in an advancement angle. In some embodiments, the guide device may be a guide shaft, a rack, or the like, any other feasible structural form.

The motor control unit is a device for controlling an automatic advancement process. In some embodiments, the motor control unit is connected to the reduction motor 23 and configured to advance the push rod by controlling the reduction motor 23.

In some embodiments, as shown in FIG. 2, the transport device may be a trolley 11, and the guide device may be a rail 12. The rail 12 is installed at a bottom portion of the trolley 11.

The trolley 11 is a movable carrying platform. The trolley 11 is configured to serve as a movable base for the motor drive unit 100 to carry and move the motor drive unit 100.

In some embodiments, the trolley 11 is divided into a front section and a rear section. The front section fixes the motor drive unit 100, and the rear section serves as the movable base, ensuring stable force bearing during advancement.

The rail 12 is a rigid track fixedly installed on an operating floor or a base. The rail 12 is configured to provide a precise, constrained path guidance for the movement of the trolley 11. The rail 12 may be made of high-strength steel, and a cross-sectional shape (e.g., I-beam, rectangular, or V-shaped) of the rail 12 is designed to precisely match rollers or sliders at the bottom portion of the trolley 11 to withstand heavy loads and ensure smooth sliding.

In some embodiments, worm gear sets 21 are installed on a left side and a right side of the front section of the trolley 11, and the push rods 25 are installed at a front portion of the worm gear sets 21 to form advancement points. The front section of the trolley 11 is a fixed installation portion for the motor drive unit, and the rear section of the trolley 11 is a movable portion.

In some embodiments, the transport device may adopt a hydraulic sliding table or a chain drive platform, and the guide device may adopt a combination of a guide shaft and a linear bearing, or a combination of a V-shaped rail and V-shaped rollers to achieve a linear guiding function.

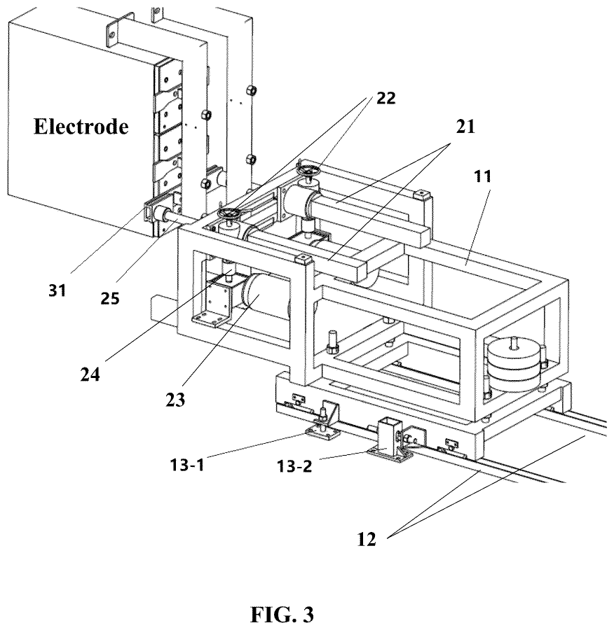

FIG. 3 is a schematic diagram illustrating an implementation of an automatic advancement device for a tin oxide electrode of an electronic glass furnace according to some embodiments of the present disclosure.

In some embodiments, as shown in FIGS. 2 and 3, the motor drive unit 100 further includes a limit device 13. The limit device 13 includes an up-down limit device 13-1 and a front-rear limit device 13-2. The up-down limit device 13-1 and the front-rear limit device 13-2 are installed at a connection between the trolley 11 and the rail 12. The up-down limit device 13-1 is configured to prevent the trolley 11 from lifting during force application, and the front-rear limit device 13-2 is configured to prevent the trolley 11 from moving backward under a reaction force (also referred to as an advancement reaction force) generated by an advancing force of the electrode.

The up-down limit device 13-1 is configured to prevent the trolley 11 from lifting upward or tilting longitudinally when subjected to the advancement reaction force. Through mechanical constraint, the up-down limit device 13-1 firmly “presses” the trolley onto the rail 12, ensuring that an advancement axis of the push rod remains horizontal, thereby preventing the worm gear set from bearing radial bending stress.

In some embodiments, the up-down limit device 13-1 may be fixedly installed on the rail 12 (or at the bottom portion of the trolley 11) via a limit docking structure. The limit docking structure of the up-down limit device 13-1 is a structure for docking with a mating component (e.g., a pin, a lug, or a latch) that fixedly installs the up-down limit device 13-1 on the rail 12 (or the bottom portion of the trolley 11).

In some embodiments, the limit docking structure of the up-down limit device 13-1 is a U-shaped notch. The U-shaped notch is an open mechanical slot resembling the shape of the English letter “U”. The U-shaped notch may consist of a movable part (installed at the bottom portion of the trolley 11) and a fixed part (installed on the rail 12 or a foundation).

When the advancement reaction force attempts to lift the front section of the trolley 11, an inner top surface of the U-shaped notch contacts the mating component, creating mechanical interference, which transfers the lifting force to the foundation via the rail 12, thereby effectively suppressing the overturning tendency of the trolley 11. A lateral opening of the U-shaped notch also facilitates quick alignment with and separation from the mating component during the installation and removal of the trolley 11.

In some embodiments, the limit docking structure of the up-down limit device 13-1 may also be a concave notch, a semi-circular notch, an inverted trapezoidal notch, or the like.

The front-rear limit device 13-2 is configured to prevent the trolley 11 from sliding backward along the rail 12 under the advancement reaction force. The front-rear limit device 13-2 may transmit a backward thrust force to the rail 12 and the foundation, ensuring that the advancement force is fully used for pushing the electrode, rather than being consumed by the backward movement of the trolley 11.

In some embodiments, the front-rear limit device 13-2 may be fixedly installed on the rail 12 (or at the bottom portion of the trolley 11) via a limit docking structure. The limit docking structure of the front-rear limit device 13-2 is a structure for docking with a mating component (e.g., a pin, a lug, or a latch) that fixedly installs the front-rear limit device 13-2 on the rail 12 (or the bottom portion of the trolley 11).

In some embodiments, the limit docking structure of the front-rear limit device 13-2 is an elongated through-hole. The elongated through-hole may consist of a connecting plate with an elongated through-hole installed on the trolley 11 and a pin fixedly installed on the rail 12. The shape of the elongated through-hole may be circular, oval, rectangular, or the like.

After the trolley is pushed to a work position, the elongated through-hole may be fitted over the fixed pin. When the advancement reaction force attempts to push the trolley 11 backward, an inner wall at a rear end of the elongated through-hole contacts the fixed pin, preventing the trolley 11 from moving backward under the advancement reaction force (the counterforce generated during propulsion). The design of the elongated through-hole allows a certain amount of front-rear adjustment margin for the trolley 11 before fixation, facilitating fine-tuning of a contact position between the push rod and the electrode. After the trolley 11 is adjusted into position, the connecting plate can be tightly fastened to the pin via a locking mechanism (e.g., a nut) to achieve rigid locking between the trolley 11 and the rail 12 (or the foundation).

One or more embodiments of the present disclosure provide the following beneficial effects: The advancement is performed by the motor control unit cooperating with the worm gear set, the coupling, the push rod, and the reduction motor, while the advancement direction is controlled on the motor guide unit. Therefore, one or more embodiments of the present disclosure can solve the problem of screw bending and jamming caused by the existing technologies when advancing the electrode. The use of motor drive is more labor-saving and efficient, provides greater pushing force, and can meet the requirements for advancing larger-sized electrodes. Through the configuration of the motor control unit, the advancement amount can be precise to the millimeter level, making it more accurate and efficient. Furthermore, the transport device adopts a trolley, the guide device adopts a rail, and the motor drive unit is installed on the trolley, which can meet operational requirements at different positions and offers greater flexibility.

In some embodiments, as shown in FIG. 1, the motor control unit further includes a current sensor 26. The motor control unit is further configured to: acquire a real-time drive current value of the reduction motor; determine a real-time output torque of the reduction motor based on the real-time drive current value; determine a real-time resistance value experienced by the push rod corresponding to the reduction motor based on the real-time output torque; in response to a difference between real-time resistance values experienced by any two push rods being greater than a skew threshold, determine a target thrust value of each of the two push rods; and control the reduction motors to advance the corresponding push rod based on the target thrust value of the corresponding push rod.

In some embodiments, the motor control unit is further configured to: determine the skew threshold by querying a first preset table based on an electrode attribute and an ambient temperature, wherein the electrode attribute includes an electrode diameter and an electrode remaining length.

In some embodiments, the motor control unit is further configured to: determine the skew threshold by querying a second preset table based on the electrode attribute, the ambient temperature, and a real-time safety margin.

In some embodiments, the motor control unit is further configured to: determine an adjustment range for the target thrust value based on a real-time safety margin; determine a corrected target thrust value by correcting the target thrust value of the push rod based on the adjustment range; and control the reduction motor to advance the push rod based on the corrected target thrust value.

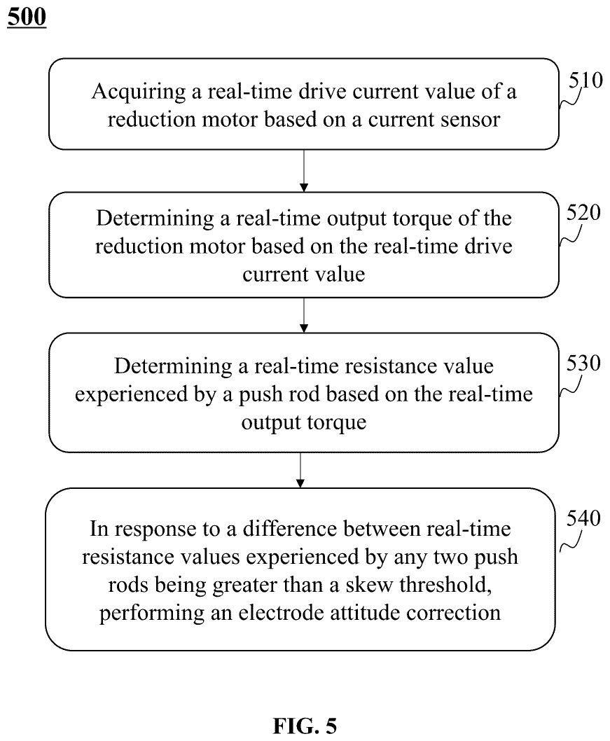

More descriptions regarding the real-time drive current value, the real-time output torque, the real-time resistance value, the skew threshold, the electrode attribute, the ambient temperature, and the determination of the skew threshold and the adjustment range for the target thrust value may be found in FIG. 5 and the related descriptions.

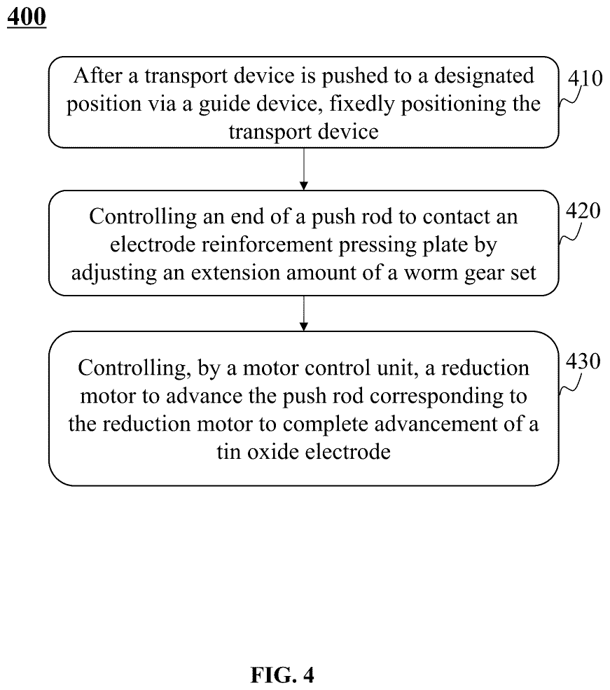

FIG. 4 is a flowchart of an exemplary automatic advancement process for a tin oxide electrode of an electronic glass furnace according to some embodiments of the present disclosure. As shown in FIG. 4, a process 400 includes the following operations. The process 400 may be executed by a motor control unit of an automatic advancement device for a tin oxide electrode of an electronic glass furnace.

In 410, after a transport device is pushed to a designated position via a guide device, the transport device may be fixedly positioned.

The designated position refers to a preset position for a tin oxide electrode advancing operation. For example, the designated position may be a position of the transport device before advancing the tin oxide electrode.

The transport device being fixedly positioned refers to an operation of securing the transport device to prevent unnecessary movement.

In some embodiments, the transport device is a trolley, and the guide device is a rail. An operator may push the trolley to the designated position along the rail and then perform fixed positioning on the trolley. For example, the operator manually pushes the trolley to move it along the rail, thereby roughly aligning a motor drive unit (e.g., a push rod of the motor drive unit) with an electrode reinforcement pressing plate inside the furnace (e.g., so that an extension of a central axis of the push rod can pass through the electrode reinforcement pressing plate). Next, a U-shaped notch of an up-down limit device is engaged downward onto a corresponding component (e.g., a pin or a latch) fixedly installed on a rail or a foundation. An elongated through-hole of the front-rear limit device is fitted over a fixed pin on the foundation. Because the elongated hole provides length allowance, the operator may perform fine front-rear adjustments of the trolley at this stage to ensure an insulating ceramic head at an end of the push rod achieves optimal contact with the electrode reinforcement pressing plate. After the fine adjustment is completed, a connecting plate is fastened to the pin via a locking mechanism (e.g., a nut), thereby completing the fixed positioning of the transport device.

In 420, an end of the push rod may be controlled to contact the electrode reinforcement pressing plate by adjusting an extension amount of a worm gear set.

The extension amount is a length by which the worm gear set extends from the designated position towards the electrode reinforcement pressing plate. For example, the extension amount is equal to a distance between the end of the push rod and the electrode reinforcement pressing plate when the transport device reaches the designated position.

In some embodiments, the extension amount of the worm gear set may be adjusted in various ways. For example, an “inching” function may be integrated into the motor control unit. The operator uses control buttons (e.g., “forward inch” and “reverse inch”) to precisely control a reduction motor to rotate for a short duration at a low speed, thereby driving the worm gear set to extend or retract minimally.

Apart from the inching mode and the preset gear mode, the motor control unit may also be set to a constant force advancement mode, in which the push rod maintains a constant thrust force through current feedback to adapt to operating conditions where the electrode consumption rate is unstable. The present disclosure does not impose limitations in this regard.

In some embodiments, the extension amount of the worm gear set is controlled by a handwheel. For example, the handwheel is configured to finely adjust the extension amount of the worm gear set, causing the end of the push rod to contact the electrode reinforcement pressing plate.

In some embodiments of the present disclosure, using the handwheel to finely adjust the extension amount of the worm gear set enables the end of the push rod to precisely contact the electrode reinforcement pressing plate, providing an accurate starting position for the subsequent automatic advancement.

In 430, the reduction motor may be controlled by the motor control unit to advance the push rod corresponding to the reduction motor to complete the advancement of the tin oxide electrode.

In some embodiments, in response to a start synchronization button being pressed, one or more motor control unit control one or more reduction motors to synchronously advance one or more push rods corresponding to the one or more reduction motors to complete the advancement of the tin oxide electrode. If the tin oxide electrode becomes deviated to one side (e.g., tilted to a left side), the motor control unit adjusts the contact between the head of the right-side push rod and the electrode reinforcement pressing plate, and a right-side independent start button is pressed to advances the push rod driven by the reduction motor to correct the leftward deviation of the tin oxide electrode.

In some embodiments, the motor control unit may preset a plurality of advancement amount gears. The reduction motor may be controlled by the motor control unit to advance the corresponding push rod according to different advancement amount gears among the plurality of advancement amount gears, and the advancement of the push rod may be stopped after an advancement amount corresponding to an advancement amount gear among the different advancement amount gears is reached.

In some embodiments, the plurality of advancement amount gears may be preset before initiating an automatic advancement program, where an operator sets, based on process requirements, specific distance values for the electrode to be advanced in the current operation on the motor control unit (e.g., a touch screen, an operation panel, or a host computer). The distance values are represented by different “gears,” each corresponding to an advancement amount (e.g., Gear 1 corresponds to an advancement amount of 2 mm, Gear 2 corresponds to an advancement amount of 5 mm). The advancement amount refers to a linear distance the push rod moves forward, i.e., a distance the tin oxide electrode is driven into the furnace.

In some embodiments, a logic controller (e.g., Programmable Logic Controller, PLC) and drive circuits are integrated into the motor control unit. The preset advancement amount (i.e., the distance value) is converted into a control signal. The logic controller calculates the count of revolutions the reduction motor needs to make based on a set distance, controls the reduction motor to rotate precisely through the drive circuits, thereby driving the worm gear set to convert the rotational motion into linear displacement of the push rod. When displacement feedback from a displacement sensor or a motor encoder reaches a preset value, the controller cuts off the motor power supply after the advancement amount corresponding to the advancement amount gear is reached, and the advancement stops.

In some embodiments, after the advancement amount corresponding to the advancement amount gear is reached, the operator may release the limit device, and the entire trolley retracts along the rail, completing the tin oxide electrode advancement operation.

In some embodiments of the present disclosure, by setting advancement amount gears and controlling the reduction motor to advance the push rod via the motor control unit, the advancement of the push rod can be precisely stopped upon reaching the corresponding advancement amount, thereby improving the precision of the tin oxide electrode advancement and enhancing the efficiency of the advancement operation.

More descriptions regarding the tin oxide electrode advancement operation may be found in FIG. 5 and the related descriptions.

In some embodiments of the present disclosure, by advancing the push rod through the coordination of the motor control unit with the worm gear set, the coupling, the push rod, and the reduction motor, problems such as screw bending and jamming found in the existing technologies can be effectively resolved, thereby successfully avoiding the potential instability and bending of traditional slender screws. In addition, motor-driven advancement is more labor-saving and efficient, and it can achieve precise advancement while providing greater pushing force.

FIG. 5 is an exemplary flowchart of a tin oxide electrode advancing process according to some embodiments of the present disclosure. As shown in FIG. 5, a process 500 may include the following operations. The process 500 may be executed by a motor control unit of an automatic advancement device for a tin oxide electrode of an electronic glass furnace.

In 510, a real-time drive current value of a reduction motor may be acquired based on a current sensor.

The current sensor refers to a sensor device installed in a power supply circuit of the reduction motor. The current sensor is configured to collect an operating current signal of the reduction motor 23 in real time. For example, the current sensor is a Hall-effect current sensor. The real-time drive current value refers to an operating current of the reduction motor during operation.

The motor control unit acquires the real-time drive current value of the reduction motor by reading a current detection signal from the current sensor.

In 520, a real-time output torque of the reduction motor may be determined based on the real-time drive current value.

The real-time output torque refers to a torque of a motor shaft of the reduction motor during the operation of the reduction motor.

The motor control unit may determine the real-time output torque using Equation (1):

$$T = K ⋆ I . \qquad ( 1 )$$

In Equation (1), T denotes the real-time output torque of the reduction motor, and the unit of T is N·m; I denotes the real-time drive current value, and the unit of I is A; K denotes a torque constant of the reduction motor, and the unit of K is N·m/A. K may be preset by the operator based on prior knowledge.

In 530, a real-time resistance value experienced by a push rod may be determined based on the real-time output torque.

The real-time resistance value is a reaction force experienced by the push rod when advancing the tin oxide electrode. The real-time resistance value is used to identify whether an attitude skew has occurred in the tin oxide electrode.

In some embodiments, the real-time resistance value is positively correlated with the real-time output torque. For example, the numerical value of the real-time resistance value equals the numerical value of the real-time output torque.

In some embodiments, the motor control unit may convert the real-time output torque into the real-time resistance value experienced by the push rod based on a transmission ratio of the worm gear set, an equivalent radius of an output shaft of the worm gear set, and a transmission efficiency of the worm gear set, using Equation (2):

$$F = ( T ⋆ i ⋆ η ) / r . \qquad ( 2 )$$

In Equation (2), I denotes the transmission ratio of the worm gear set, r denotes the equivalent radius of the output shaft of the worm gear set, η denotes the transmission efficiency of the worm gear set, T denotes the real-time output torque, and F denotes the real-time resistance value experienced by the push rod.

In 540, in response to a difference between real-time resistance values experienced by any two push rods being greater than a skew threshold, an electrode attitude correction may be performed.

The skew threshold refers to the maximum tolerable value for the difference in the real-time resistance values experienced by the push rods. The unit of the skew threshold is N. Skew thresholds corresponding to different push rods may be the same or different.

In some embodiments, the skew threshold is a value preset by the operator.

In some embodiments, the motor control unit may determine the skew threshold by querying a first preset table based on an electrode attribute and an ambient temperature.

The electrode attribute is a set of parameters characterizing a physical structure and a remaining life of the electrode. In some embodiments, the electrode attribute includes an electrode diameter and an electrode remaining length.

The electrode diameter refers to an effective contact diameter at a front end of the electrode. The size of the electrode diameter affects a force-bearing area of the push rod.

In some embodiments, the electrode diameter may be determined based on factory parameters of the electrode. The electrode diameter remains substantially unchanged during the service life of the motor.

The electrode remaining length refers to an effective residual length of the electrode. The electrode remaining length gradually shortens during use. The electrode remaining length affects the overall rigidity and force-induced deformation of the electrode.

In some embodiments, the electrode remaining length may be determined by using a high-temperature industrial camera or an infrared camera to identify positions of marks on an end surface of the electrode. By analyzing a distance between different positions, an actual exposed length of the electrode may be determined, which is designated as the electrode remaining length.

The ambient temperature refers to an actual temperature of a space where the automatic advancement device is located. The ambient temperature may be acquired via a temperature sensor. The ambient temperature affects a thermal expansion of the electrode, a frictional force on the push rod, a lubrication state, etc., thereby influencing skew sensitivity of the electrode.

The first preset table refers to a data table for retrieving and determining the skew threshold. The first preset table may include combinations of different electrode attributes and ambient temperatures, and their corresponding relationships with different skew thresholds. For example, the thinner the electrode (i.e., the smaller the electrode diameter) and the shorter the electrode remaining length, the poorer the structural rigidity of the electrode and the more prone the electrode is to skewing. Therefore, the skew threshold is positively correlated with the electrode diameter and the electrode remaining length. The higher the ambient temperature, the more significant the material softening. Therefore, the skew threshold is negatively correlated with the ambient temperature. Merely by way of example, the first preset table may include electrode diameters (Φ100 mm, Φ150 mm), electrode remaining lengths (>1m, 0.5-1m, <0.5m), and ambient temperatures (<100° C., 100-200° C.), with corresponding skew thresholds ranging between 200 N and 1000 N.

In some embodiments, the first preset table may be constructed based on historical advancement records of stable electrode attitude correction (e.g., successful completion of an advancement task without failures such as bending, jamming, or fracture damage of the push rod 25).

For example, the motor control unit may store and record a large number of historical advancement records where stable electrode attitude correction was achieved under different operating condition parameters. A single historical advancement record includes an electrode diameter, an electrode remaining length, an ambient temperature, and a maximum difference between real-time resistance values experienced by different push rods during the electrode advancement process. The motor control unit may designate the maximum difference as the skew threshold corresponding to the historical advancement record and record the correspondence between the skew threshold and the relevant data of the historical advancement record (including the electrode diameter, the electrode remaining length, and the ambient temperature) into the first preset table.

In some embodiments, a real-time safety margin is also considered when determining the skew threshold.

The real-time safety margin refers to a remaining load capacity that the push rod can withstand during the electrode advancement process. The real-time safety margin may be a difference between a preset safety threshold and an actual resistance value on the push rod (e.g., the largest value among the real-time resistance values of different push rods). The preset safety threshold may be set by the operator based on experience.

In some embodiments, the motor control unit may determine the skew threshold by querying a second preset table based on the electrode attribute, the ambient temperature, and the real-time safety margin.

The second preset table is another data table for determining the skew threshold. The second preset table may include combinations of different electrode attributes, ambient temperatures, and real-time safety margins, and their corresponding relationships with different skew thresholds. For example, when the real-time resistance value is much smaller than the preset safety threshold (e.g., the real-time resistance value is less than 60% of the preset safety threshold), it indicates a relatively large real-time safety margin, and the skew threshold is set to a relatively large value. When the real-time resistance value approaches the preset safety threshold (e.g., the real-time resistance value is greater than 90% of the preset safety threshold), it indicates a relatively small real-time safety margin. In this case, even slight asymmetry may cause local overload of the electrode or imbalance in structural forces. Therefore, a relatively small skew threshold may be set to enable more sensitive triggering of attitude correction.

The second preset table incorporates data on the real-time safety margin on the basis of the first preset table. The process for constructing the second preset table may refer to the construction process of the first preset table described above and will not be repeated here.

In some embodiments of the present disclosure, dynamically setting the skew threshold by incorporating information such as the electrode diameter, the remaining length, and the ambient temperature can improve the adaptability and accuracy of skew judgment. By introducing the real-time safety margin into the regulation process of the skew threshold, the skew threshold can be dynamically adjusted according to the current load state, achieving conservative control under high loads and rapid response under low loads, thereby effectively enhancing the stability and safety of attitude correction.

The electrode attitude correction is an operation performed during the automatic advancement process of the tin oxide electrode in the electronic glass furnace to detect and rectify asynchronous advancement of multiple electrodes, thereby preventing electrode skewing.

In some embodiments, the electrode attitude correction includes: determining a target thrust value of each of the any two push rods; and controlling the reduction motor to advance the corresponding push rod based on the target thrust value to complete the advancement of the tin oxide electrode.

The target thrust value is a redefined target output thrust of the reduction motor for correcting the skew. The target thrust value guides the subsequent adjustment of the reduction motor to restore the attitude of the tin oxide electrode.

In some embodiments, the motor control unit may determine the target thrust values of different push rods via an algorithm. For example, the motor control unit may employ a mean alignment technique to determine the target thrust value.

By way of example, assume there are two push rods, where the real-time resistance value of one push rod is 2700 N and the real-time resistance value of the other push rod is 3100 N. If the motor control unit determines that the two push rods have developed an attitude skew, it triggers the electrode attitude correction and sets the target thrust value to a mean value of the real-time resistance values of the two push rods (i.e., 2900 N).

In some embodiments, the motor control unit may determine a target output torque based on the target thrust value, then determine a target current value based on a motor torque constant and the target output torque. The motor control unit may adjust a drive signal of the reduction motor based on the target current value, causing each push rod to operate according to the target thrust value, thereby pushing the electrode to maintain attitude balance and complete the advancement operation of the tin oxide electrode. The target current value is a current value required to adjust the drive signal of the reduction motor so that the push rod operates at the target thrust value.

For example, the motor control unit may determine a ratio of the target output torque to the motor torque constant as the target current value.

In some embodiments, the motor control unit may determine an adjustment range for the target thrust value based on the real-time safety margin; determine a corrected target thrust value by correcting the target thrust value of the push rod based on the adjustment range; and control the reduction motor to advance the push rod based on the corrected target thrust value to complete the advancement of the tin oxide electrode.

In some embodiments, the adjustment range for the target thrust value is positively correlated with the real-time safety margin.

For example, the adjustment range for the target thrust value may be determined using Equation (3):

$$Δ F = B + K ⋆ H . \qquad ( 3 )$$

In Equation (3), ΔF denotes the adjustment range for the target thrust value, and the unit of ΔF is N; B denotes a base adjustment range for the target thrust value, preset by the operator based on experience or historical data, and the unit of B is N; K denotes an adjustment coefficient, which is a dimensionless value; H denotes the real-time safety margin.

Correction refers to an operation of regulating the target thrust value.

In some embodiments, the motor control unit may subtract the adjustment range from the target thrust value to determine the corrected target thrust value.

In some embodiments, the motor control unit may correct the target thrust value of the push rod using an iterative correction approach.

For example, within each control cycle, using the calculated adjustment range ΔF for the target thrust value as a step size, the target thrust values of different push rods are fine-tuned to gradually approach the final target thrust value.

By way of example, assume there are two push rods. The motor control unit detects that the real-time resistance value of a left push rod is 2700 N and the real-time resistance value of a right push rod is 3100 N. In response to a difference between the real-time resistance values of the two push rods exceeding the skew threshold, the electrode attitude correction is triggered, and the motor control unit sets the mean value of the two real-time resistance values as the target thrust value. If the adjustment range for the target thrust value is determined to be ΔF=50 N based on the real-time safety margin, the motor control unit may set a time-ordered advancement adjustment sequence for the left push rod as (2700 N, 2750 N, 2800 N, 2850 N, 2900 N) and set a time-ordered advancement adjustment sequence for the right push rod as (3100 N, 3050 N, 3000 N, 2950 N, 2900 N).

In some embodiments, within each control cycle, the motor control unit determines a target output torque for the reduction motor based on the corrected target thrust value and further determines a corresponding target current value. The motor control unit adjusts the drive signal of the reduction motor based on the target current value, thereby controlling different push rods to advance based on their respective corrected target thrust values.

In some embodiments, the corrected target thrust value is dynamically updated with each control cycle. The electrode attitude is gradually corrected over multiple advancement cycles, ultimately completing automatic correction and enabling stable, non-skewed advancement of the tin oxide electrode.

In some embodiments of the present disclosure, by dynamically setting the adjustment range for the target thrust value based on the real-time safety margin and iteratively correcting the thrust of different push rods in steps, the system can enhance response speed while avoiding oscillation in the automatic advancement device, achieving stable, non-skewed advancement of the tin oxide electrode.

In some embodiments of the present disclosure, by acquiring the real-time drive current value of the reduction motor and converting the real-time drive current value into the real-time resistance value on the push rod, the force state during the electrode advancement process can be efficiently identified. Subsequently, based on the difference between real-time resistance values of different push rods, the electrode attitude correction is performed on the electrode, thereby achieving dynamic thrust distribution and effectively preventing electrode skewing and push rod overload.

As known from technical common knowledge, the present disclosure may be implemented through other embodiments that do not depart from its spirit or essential characteristics. Therefore, the disclosed embodiments above are merely illustrative in all respects and not exhaustive. All changes falling within the scope of the present disclosure or equivalents thereto are encompassed by the present disclosure.

In the description of operations performed step by step in the embodiments of the present disclosure, unless otherwise specified, the sequence of steps is interchangeable, steps may be omitted, and other steps may be included during the operation.

The description of the system and its modules in the embodiments of the present disclosure is for convenience of description only and is not intended to limit the scope to the exemplified embodiments. Various modules may be combined arbitrarily, or form subsystems connected with other modules, without departing from the principles of the system.

The embodiments in the present disclosure are for illustration and description only and do not limit the applicable scope of the present disclosure. Various modifications and changes that may be made by those skilled in the art under the guidance of the present disclosure still fall within the scope of the present disclosure.

Certain features, structures, or characteristics in one or more embodiments of the present disclosure may be appropriately combined.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Various aspects of the present disclosure may be implemented entirely in hardware, entirely in software (including firmware, resident software, microcode, etc.), or by a combination of hardware and software. The aforementioned hardware or software may be referred to as a “block,” “module,” “engine,” “unit,” “component,” or “system,” etc. Furthermore, aspects of the present disclosure may be embodied as a computer product located in one or more computer-readable media, the product comprising computer-readable program code.

A computer storage medium may be any computer-readable medium that can be connected to an instruction execution system, apparatus, or device to enable communication, propagation, or transmission of a program for use. Program code located on a computer storage medium may be propagated via any suitable medium, including radio, cable, fiber optic cable, radio frequency (RF), or similar mediums, or any combination of the aforementioned mediums.

Computer program code required for the operations of various parts of the present disclosure may be written in any one or more programming languages. The program code may execute entirely on a user's computer, execute as a standalone software package on a user's computer, execute partly on the user's computer and partly on a remote computer, or execute entirely on a remote computer or processing device. In the latter scenario, the remote computer may be connected to the user's computer through any type of network, such as a local area network (LAN) or a wide area network (WAN), or connected to an external computer (e.g., via the Internet), or in a cloud computing environment, or used as a service such as Software as a Service (SaaS).

Finally, it should be understood that the embodiments described in the present disclosure are merely illustrative of the principles of the embodiments of the present disclosure. Other variations may also fall within the scope of the present disclosure. Accordingly, alternative configurations of the embodiments of the present disclosure are to be considered as consistent with the teachings of the present disclosure, by way of example and not limitation. Consequently, the embodiments of the present disclosure are not limited to those explicitly introduced and described herein.

What is claimed is:

1. An automatic advancement device for a tin oxide electrode of an electronic glass furnace, comprising:
at least one motor drive units, each of the at least one motor drive unit including a worm gear set, a coupling, a push rod, and a reduction motor, wherein the worm gear set is connected to the reduction motor via the coupling, and the push rod is installed at an end of the worm gear set;
a motor guide unit, including a transport device and a guide device, wherein the motor drive unit is installed on the transport device, and the guide device is installed at a bottom of the transport device, the transport device moves along the guide device to control an advancement direction of the motor drive unit during use; and
a motor control unit, connected to the reduction motor, and configured to control the reduction motor to advance the push rod.

2. The automatic advancement device for the tin oxide electrode of the electronic glass furnace of claim 1, wherein the motor drive unit further includes a handwheel, and the handwheel is disposed at an upper end of the worm gear set.

3. The automatic advancement device for the tin oxide electrode of the electronic glass furnace of claim 1, wherein the transport device is a trolley, the guide device is a rail, and the rail is installed at a bottom portion of the trolley.

4. The automatic advancement device for the tin oxide electrode of the electronic glass furnace of claim 3, wherein the motor drive unit further includes an up-down limit device and a front-rear limit device, and the up-down limit device and the front-rear limit device are installed at a connection between the trolley and the rail.

5. The automatic advancement device for the tin oxide electrode of the electronic glass furnace of claim 4, wherein a limit docking structure of the up-down limit device is a U-shaped notch.

6. The automatic advancement device for the tin oxide electrode of the electronic glass furnace of claim 4, wherein a limit docking structure of the front-rear limit device is an elongated through-hole.

7. The automatic advancement device for the tin oxide electrode of the electronic glass furnace of claim 1, wherein an end of the push rod is provided with an insulating ceramic head.

8. The automatic advancement device for the tin oxide electrode of the electronic glass furnace of claim 1, wherein the motor drive unit further includes a current sensor; and the motor control unit is further configured to:
acquire a real-time drive current value of the reduction motor;
determine a real-time output torque of the reduction motor based on the real-time drive current value;
determine a real-time resistance value experienced by the push rod based on the real-time output torque;
in response to a difference between real-time resistance values experienced by any two push rods being greater than a skew threshold, determine a target thrust value of each of the any two push rods; and
control the reduction motor to advance the corresponding push rod based on the target thrust value of the corresponding push rod.

9. The automatic advancement device for the tin oxide electrode of the electronic glass furnace of claim 8, wherein the motor control unit is further configured to:
determine the skew threshold by querying a first preset table based on an electrode attribute and an ambient temperature, wherein the electrode attribute includes an electrode diameter and an electrode remaining length.

10. The automatic advancement device for the tin oxide electrode of the electronic glass furnace of claim 9, wherein the motor control unit is further configured to:
determine the skew threshold by querying a second preset table based on the electrode attribute, the ambient temperature, and a real-time safety margin.

11. The automatic advancement device for the tin oxide electrode of the electronic glass furnace of claim 8, wherein to control the reduction motor to advance the corresponding push rod based on the target thrust value, the motor control unit is further configured to:
determine an adjustment range for the target thrust value based on a real-time safety margin;
determine a corrected target thrust value by correcting the target thrust value of the push rod based on the adjustment range; and
control the reduction motor to advance the push rod based on the corrected target thrust value.

12. An automatic advancement method for a tin oxide electrode of an electronic glass furnace, implemented based on the automatic advancement device of claim 1, the method comprising:
after pushing the transport device to a designated position via the guide device, fixedly positioning the transport device;
controlling an end of the push rod to contact an electrode reinforcement pressing plate by adjusting an extension amount of the worm gear set; and
controlling, by the motor control unit, the reduction motor to advance the corresponding push rod to complete advancement of the tin oxide electrode.

13. The automatic advancement method of claim 12, wherein the extension amount of the worm gear set is controlled by a handwheel.

14. The automatic advancement method of claim 12, further comprising:
presetting a plurality of advancement amount gears;
controlling, by the motor control unit, the reduction motor to advance the corresponding push rod according to different advancement amount gears among the plurality of advancement amount gears; and
stopping the advancement of the push rod after an advancement amount corresponding to an advancement amount gear among the different advancement amount gears is reached.

15. The automatic advancement method of claim 12, wherein the motor drive unit further includes a current sensor; and the controlling, by the motor control unit, the reduction motor to advance the corresponding push rod to complete the advancement of the tin oxide electrode includes:
acquiring a real-time drive current value of the reduction motor based on the current sensor;
determining a real-time output torque of the reduction motor based on the real-time drive current value;
determining a real-time resistance value experienced by the push rod based on the real-time output torque;
in response to a difference between real-time resistance values experienced by any two push rods being greater than a skew threshold, performing an electrode attitude correction, wherein the electrode attitude correction includes:
determining a target thrust value of each of the any two push rods; and
controlling the reduction motor to advance the corresponding push rod based on the target thrust value of the corresponding push rod to complete the advancement of the tin oxide electrode.

16. The automatic advancement method of claim 15, further comprising:
determining the skew threshold by querying a first preset table based on an electrode attribute and an ambient temperature, wherein the electrode attribute includes an electrode diameter and an electrode remaining length.

17. The automatic advancement method of claim 16, wherein a real-time safety margin is further considered when determining the skew threshold.

18. The automatic advancement method of claim 15, wherein the controlling the reduction motor to advance the corresponding push rod based on the target thrust value of the corresponding push rod to complete the advancement of the tin oxide electrode includes:
determining an adjustment range for the target thrust value based on a real-time safety margin;
determining a corrected target thrust value by correcting the target thrust value of the corresponding push rod based on the adjustment range; and
controlling the reduction motor to advance the corresponding push rod based on the corrected target thrust value to complete the advancement of the tin oxide electrode.
